(19) United States
(12) Patent Application Publication
(10) Pub. No.: US 2021/0108804 A1
(43) Pub. Date: Apr. 15, 2021

(54) THERMODYNAMIC CO2 BOILER AND THERMAL COMPRESSOR

(71) Applicant: BOOSTHEAT, Vénissieux (FR)

(72) Inventor: Jean-Marc JOFFROY, Cabanes (FR)

(21) Appl. No.: 16/606,682

(22) PCT Filed: Apr. 12, 2018
(86) PCT No.: PCT/FR2018/050925

§ 371 Date: Oct. 18, 2019

(30) Foreign Application Priority Data
Apr. 20, 2017 (FR) 17 53447

(51) Int. Cl. F24D 3/18; F04B 49/20; F24H 9/00; F25B 9/00; F25B 30/02; F04B 35/00; F04B 35/04; F04B 41/06

(52) U.S. Cl. CPC F24D 3/18; F04B 49/20; F24H 9/0084; F25B 9/008; F24D 2200/04; F04B 35/00; F04B 35/04; F04B 41/06; F25B 30/02

(57) ABSTRACT

A thermodynamic boiler for delivering heat into at least one heating circuit, includes a compressor forming the compression function of a heat pump type loop using a compressible fluid of type R744, and includes a fuel burner which delivers heat into the compressible fluid.

### BACKGROUND

### Technical Field

The present invention relates to heating systems that include devices called boilers. It particularly concerns thermodynamic boilers which make use of a device called a heat pump (abbreviated as “HP”).

### Description of the Related Art

Several technical solutions already exist for implementing a heat pump device in the context of a boiler.

Firstly, the use of electric compressors for compressing and circulating a heat-transfer working fluid is known. The term “electric HP” is also used.

Gas-engine heat pumps (“gas-engine HP”) are also known. This system involves the use of an internal combustion engine that is noisy and requires regular maintenance.

Desorption/adsorption gas heat pumps, such as those using paired water/ammonia or water/zeolite, are also known. But these devices are complex and expensive; moreover, they use potentially polluting or harmful materials.

In addition, it is generally preferable that this type of boiler be power-adjustable and also be able to provide domestic hot water (“DHW”) on demand.

Moreover, in general, it is well known that the performance of the heat pump loop decreases substantially when the outside temperature is low, particularly in aerothermal energy systems, especially below 0° C., and the collection of heat energy from the exterior becomes almost negligible or even zero at outside temperatures below −10° C.

This is the reason why many boilers are equipped with a booster burner (or “backup” burner) separate from the compressor of the heat pump, which delivers heat into the heating circuit, for example as taught by WO2014083440. These boilers are called “hybrids” because they combine a heat pump circuit and a conventional backup burner. However, these “hybrid” boilers are relatively complex and expensive.

Given this context, a need therefore remains for providing more optimized solutions for thermodynamic boiler systems with a heat pump effect.

For this purpose, a thermodynamic boiler for delivering heat into at least one heating circuit (30) is proposed, the boiler comprising at least one compressor (M1) forming the compression function of a heat pump type loop (31, 34) using a refrigerant, the boiler further comprising a fuel burner (11) which delivers heat at least into the refrigerant, the fuel burner delivering the heat into the refrigerant, downstream of the compressor.

With these arrangements, the “booster” or “backup” heat is delivered into the refrigerant circuit, which simplifies the architecture of the boiler and makes it possible to use preferably a single heat exchanger with the heating circuit for the HP function and the “backup” function.

Advantageously, a compressible fluid of type R744 (in other words essentially CO2) is chosen as the refrigerant.

Note 1: In the abovementioned heat pump type loop with compressible fluid of type R744, an evaporation phenomenon is exploited in one exchanger and a cooling/condensation phenomenon in another exchanger. It should be noted that according to the present invention, it is equally possible to use any type of refrigerant having physical properties close to those of R744.

Note 2: Regarding the vocabulary used in this document, it should be noted that what is referred to here as a “heating circuit” is to be interpreted broadly as a main circuit for exchanging heat with an entity of interest, most often premises, the goal being to heat the premises, but in some cases, particularly when the heat pump is reversible, the system can be used to cool the premises.

### BRIEF SUMMARY

In various embodiments of the invention, one or more of the following arrangements may also be used.

According to one aspect of the invention, the compressor is a heat compressor comprising at least one compression stage with reciprocating piston, the fuel burner further forming the heat source of the compressor and the heating circuit forming the cold source of the compressor. Under these conditions, from a heat efficiency point of view, all the energy generated in the burner is either used directly for compression or diffused directly into the compressible fluid, and a portion in the form of exhaust gases can be diffused in the heating circuit.

According to one aspect of the invention, the thermodynamic boiler comprises a domestic hot water circuit. Advantageously, it is possible to deliver sufficient power to have almost instantaneous availability of the domestic hot water, without the need for a storage tank of substantial size.

According to one aspect of the invention, the compressor burner forms the only burner of the boiler. With this single burner, one is able to meet energy requirements including spikes during peak hours (drawing hot water, bringing a second home to normal temperatures).

According to one aspect, the thermodynamic boiler comprises a circuit (38) for superheating the compressible fluid that circulates in the compressor burner, and a booster control valve (75) to allow a controlled portion of the compressible fluid to circulate in said superheating circuit; whereby the boiler can operate with modulated boost or without boost depending on the position of the booster control valve. In addition, the booster power is advantageously modulatable according to the amount of gas injected into the burner and the degree to which the booster control valve is open.

According to one aspect, the compressor burner allows delivering all the power of the boiler and preferably has a power of between 20 and 25 kW. This power is sufficient for a typical house with for example 100 m² and 4/6 people.

According to one aspect, the thermodynamic boiler may comprise an exchanger (5) forming the essential heat interface between the compressible fluid circuit (31) and the heating circuit (30), the exchanger comprising a high temperature exchanger (50) and a low temperature exchanger (51), the high temperature exchanger being coupled to the domestic hot water circuit; this makes it possible to have hot water produced at a high temperature, available almost immediately.

According to one aspect, the heat pump type loop may comprise two circuits in cascade, namely a working circuit of compressible R744 gas (31,M1,5,7,6) and a circuit of glycolated water (34,4,6), so that the CO2 circuit can be confined within the boiler, without the plumber doing the final on-site installation needing to work on the CO2 circuit.

According to one aspect, there may be provided a modulation unit and a motor (17) for regulating, namely increasing and/or decreasing, the rotational speed of the compressor; it is thus possible to adapt the rotational speed of the compressor in real time to the demand for heating and hot water.

According to one aspect, the compressor may comprise at least two compression stages in series, namely a second compression stage (U2); whereby the CO2 type fluid (R744) can be used with large pressure swings and CO2 fluid temperatures adapted according to the temperatures of the water circuits to be heated. Good overall thermodynamic efficiency is thus obtained.

According to one aspect, the compressor may comprise three stages; whereby the staging of the pressure increases and the adequacy of the CO2 fluid temperatures adapted according to the temperatures of the water circuits to be heated and the thermal power to be delivered are optimized.

According to one aspect, the stages are advantageously independent. This facilitates sizing and increases the modulation possibilities of each stage.

According to one aspect, the compressor may comprise at least two compression stages in parallel. This represents an alternative configuration to the serial configuration.

According to one aspect, the thermodynamic boiler may include an air preheater (9) at the inlet of the first burner. Heat energy is thus recovered from the combustion exhaust gases and injected into the air for the burner; this improves the overall coefficient of performance.

According to one configuration, called heating, the thermodynamic boiler supplies heat energy to the heating circuit (“heating” or “winter” mode), and the reversible heat pump type loop takes heat from an exterior unit.

According to another configuration, called air conditioning, the thermodynamic boiler takes heat from the heating circuit 30, and delivers this heat either into the domestic hot water circuit DHW or into the exterior unit 4 (summer mode); thus the boiler can provide an air conditioning function, and in addition domestic hot water that is free energy-wise.

### BRIEF DESCRIPTION OF THE SEVERAL VIEWS OF THE DRAWINGS

Other features, objects, and advantages of the invention will be apparent from reading the following description of one embodiment of the invention, given as a non-limiting example. The invention will also be better understood with reference to the accompanying drawings in which:

FIG. 1 schematically represents a heating system comprising a boiler according to the invention,

FIG. 2 represents a system similar to FIG. 1, the boiler comprising a heat compressor,

FIG. 3 represents a system similar to FIG. 2, in which the boost is delivered directly into the hot portion of the heat compressor,

FIG. 4 schematically represents a stage of the heat compressor,

FIG. 5 illustrates a power vs temperature diagram,

FIG. 6 represents a stage of the heat compressor in more detail,

FIG. 7 illustrates the thermodynamic cycle,

FIG. 8 illustrates the three-stage configuration of the heat compressor,

FIG. 9 schematically represents a diagram of the regulation system,

FIG. 10 illustrates the reversibility of the heat pump loop.

### DETAILED DESCRIPTION

In the different figures, the same references designate identical or similar elements.

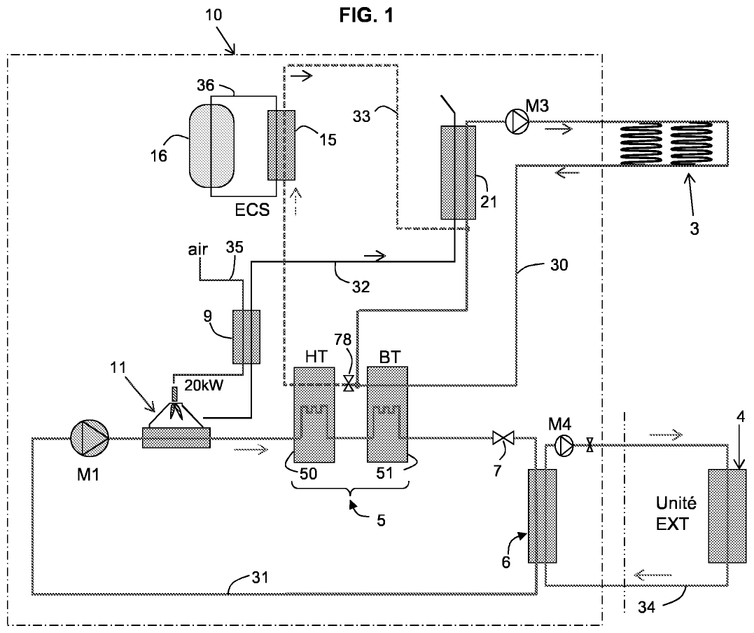

FIG. 1 shows an overview of a heating system typically provided for heating industrial premises or individual or collective housing. The heating system comprises a boiler 10 which will be described below.

The system comprises a heating circuit denoted 30; as stated at the beginning, the term “heating circuit” does not exclude the circuit from drawing heat, however in the first example as illustrated, the heating circuit comprises heat-receiving entities 3 in the form of radiators/convectors 3 and/or underfloor heating, located in the rooms of the premises to be heated.

There may be several heat-receiving entities, for example one at low temperature (underfloor heating) and another at higher temperature (convectors, domestic hot water). A circulator M3 circulates water in the heating circuit 30.

The case where the heat-receiving entity is a pool or a greenhouse can also be handled. Similarly, the heating system can be used in an industrial context with the heat-receiving entity in the form of industrial process equipment.

Production of domestic hot water (“DHW”) is provided, with a storage tank 16 for domestic hot water as is known per se so not described in detail here. The water in this storage tank is heated by a circulation of fluid 36 during its passage through a DHW exchanger 15.

Advantageously in the context of the present invention, the volume of the storage tank 16 can be very small, for example 5 liters, generally less than 10 liters.

In this DHW exchanger 15 circulates a bypass branch 33 of the heating circuit 30. This bypass branch takes heat from a high temperature heat exchanger (HT) denoted 50 and transmits it to the domestic hot water via the DHW exchanger 15.

The flow rate of fluid in the bypass branch 33 can be controlled by a DHW control valve 78 that is known per se. This flow rate is determined in proportion to the requirements of the regulation system of the domestic hot water storage tank.

The boiler 10 comprises a compressor M1 which constitutes the driving component of a heat pump circuit. In the example shown, only the exterior unit denoted 4 is arranged outside the premises (building, dwelling, etc.), the rest of the main components being arranged inside the premises, or even within the casing of the boiler 10.

Note that in the figures, the pipes are represented symbolically.

The heat pump device comprises a glycolated water circuit 34 which circulates in the exterior unit 4, and a working fluid circuit 31 which passes through the compressor M1. In the illustrated example, the working fluid is R744, in other words CO2, but another fluid with similar properties could be chosen. In order to distinguish it from other fluids, the working fluid of the circuit 31 will be referred to below as the “compressible” fluid (also called “refrigerant” in the art). This is in contrast to the fluid flowing outwardly in the exterior unit (circuit 34) which is mainly water-based (glycolated water), and also in contrast to the fluid flowing in the already mentioned heating circuit 30 which is also mainly based on water, and therefore non-compressible.

The various fluids used in the circuits 30, 31, 34 are heat transfer fluids; whether or not they are compressible, they make it possible to transfer calories primarily from the exterior unit 4 to the receiving entities 3, but also from the burner 11 to the receiving entities 3.

Air conditioning mode, which is also possible, will be described further below.

It should be noted that the exterior unit 4 may be an aerothermal or geothermal unit.

One will note that the capture of external heat by heat pump effect uses two circuits of fluid in series which are interfaced by the exchanger 6, called the interface exchanger 6, which is preferably cross-flow. The glycolated water circuit 34 comprises a circulator M4, recovers heat from the exterior unit 4 and delivers this heat to the interface exchanger 6. It can be seen that the entire compressible fluid circuit 31, namely the CO2 circuit, is confined to inside the boiler 10 which is prepared in the manufacturing plant; only the glycolated water circuit 34 must be implemented by a professional at the target facility.

In addition, the heat pump device comprises a relief valve 7, known per se, which plays the inverse role to the compressor for the pressure, and an exchanger 5 which thermally couples the compressible fluid circuit 31 exiting the compressor with the heating circuit 30.

The exchanger 5 here comprises two exchangers arranged in series on the CO2 circuit 31: the “high temperature HT” exchanger 50 in which circulates the bypass 33 configured for heating the domestic hot water, and the “low temperature LT” exchanger 51 which forms the main coupling of the CO2 circuit 31 with the heating circuit 30.

The main exchanger 5 could also form a single exchanger with a first portion coupled to the domestic hot water circuit 33 and a second portion coupled to the heating circuit 30.

The compressible fluid circuit 31 contains fluid in two-phase form which recovers heat from the interface exchanger 6 (“evaporator” side where the two-phase fluid goes from liquid state to vapor state) and delivers this heat to the main exchanger 5 (“condenser” side where the two-phase fluid cools down). The compressible fluid cools in the exchanger 5, but remains essentially in the vapor phase; it is by undergoing expansion at the expansion valve 7 that it essentially changes to the liquid phase.

In the configuration of FIG. 1, the compressor M1 may be a compressor with an electric motor; in this case, downstream of the compressor a booster burner 11 is provided which delivers heat directly into the compressible fluid, downstream of the compressor, with modulated power sufficient for the energy demand in the heating circuit and/or domestic hot water circuit.

Note that the backup heat is delivered in the compressible fluid and not in an exchanger directly coupled to the heating circuit.

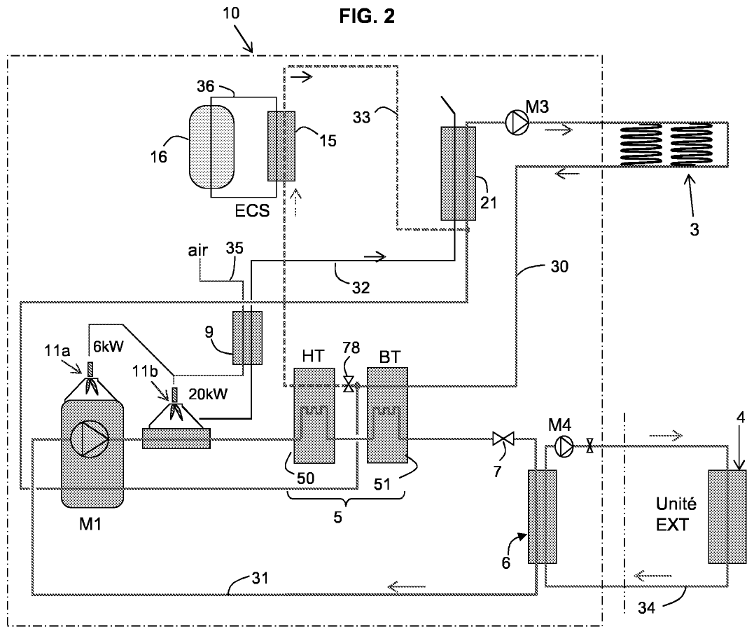

In the configuration of FIG. 2, the compressor M1 may be a compressor of the type driven by a gas engine. The gas engine uses a burner denoted 11a. The gas engine drives said compressor M1 and another burner 11b forms the heat booster in the compressible fluid circuit as in the previous case, in other words downstream of the compressor M1.

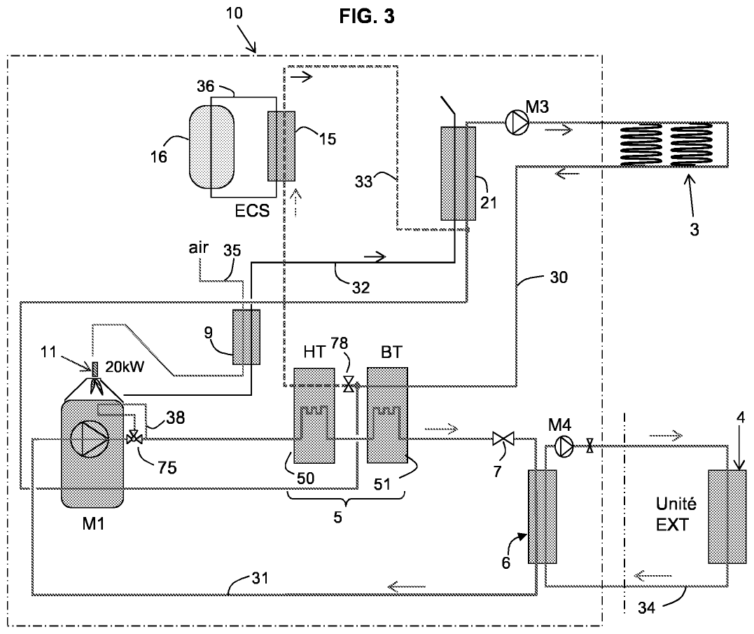

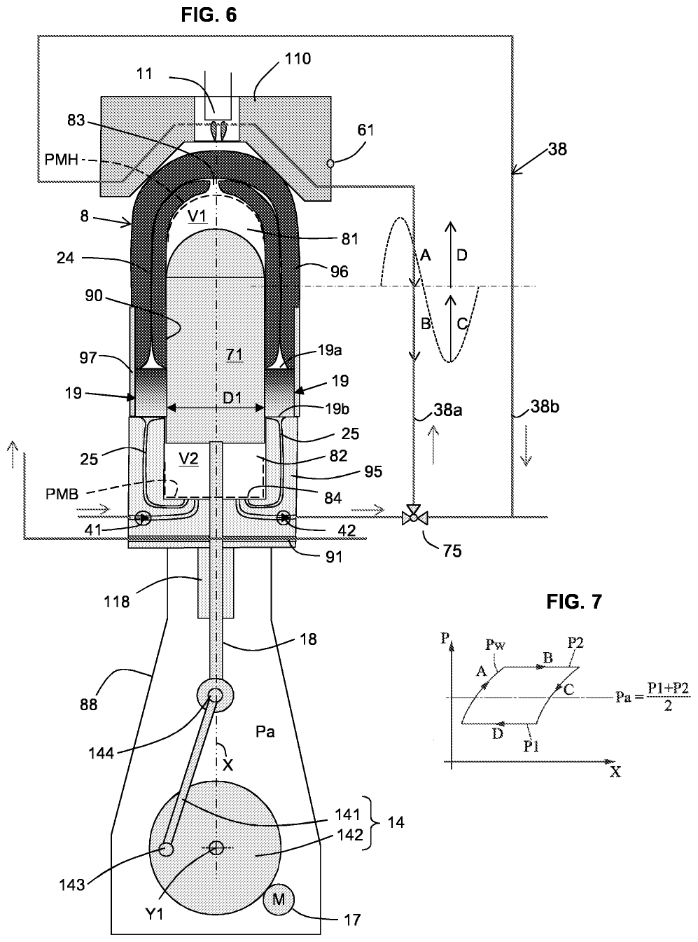

In the configuration of FIG. 3, the compressor M1 is a heat compressor, meaning it uses heat energy as a heat source and uses a cold source to activate a piston whose reciprocating movement and the use of check valves form the compressor. An example of this type of heat compressor is disclosed in detail in WO2014202885 and in FIG. 6 of the present document.

In the configuration of FIG. 3, there is only one burner 11 which forms both the heat source of the heat compressor M1 and the heat booster, because advantageously, at the exit of the compression stage, the R744 compressible fluid is directed towards the burner environment of the compressor and circulates there in order to take heat energy from the burner (without supplemental compression at this location). In FIGS. 3,4,6,8, this circuit for circulation in the hot section of the compressor is denoted 38. It is also referred to in the rest of this document as the “superheating circuit” 38. The superheating circuit 38 comprises a first portion also called the upstream portion 38a and a second portion also called the downstream portion 38b.

One will note that circulation in the hot section of the compressor is determined by a booster control valve 75 which is open to any degree between two positions, a first extreme position in which all the CO2 is directed towards the hot section of the compressor (case of booster needed), and a second extreme position (all closed) in which all the CO2 is directed directly towards the main heat exchanger 5 with the heating circuit, without passing through the hot section of the compressor.

One will note that when the compressor M1 is running and the selection valve 75 is in the fully closed position, there is working fluid which stagnates in the superheating circuit 38, where its temperature increases to a temperature close to the temperature of the burner, typically between 600° C. and 700° C. (see below). However, because of the physical properties of the chosen fluid, in other words the CO2, there is no risk of high overpressure or explosion.

When the compressor is running and the selection valve is in the first position, in the downstream portion 38b of the recirculation circuit, the temperature of the CO2 compressible fluid is between 100° C. and 300° C., depending on the boost power supplied at the burner.

In the configuration of FIG. 3, the power delivered to the single burner 11 can be modulated between 0 and 20 kW. When the compressor is running without any boost being necessary, the delivered power is in particular between 3 and 6 kW. When the boost is necessary, the compressor is running (representing 3 to 6 kW) and the rest of the power (representing 2 to 15 kW) is supplied from the burner directly to the working fluid which is recirculating in the superheating circuit 38.

The equilibrium between the powers involved is illustrated in FIG. 5. The curve labeled 95 “available power without booster” represents the sum of the power supplied by the compressor and the free collection of energy in the external environment. Curves 96a 96b 96c represent the demand for heating for three types of dwelling, in a steady state.

The “booster needed” case arises when the outside temperature is within the region below a threshold of around −5° to 0° C.

In addition, this diagram does not represent demand spikes, such as the production of domestic hot water that depends on the number of people using the shower, toilet, kitchen appliances, etc. This diagram also does not represent the demand spike when restoring an only occasionally occupied dwelling to its normal temperatures.

In the configuration of FIGS. 2 and 3, one will note that the return of the heating circuit 30 first passes through the main heat exchanger 5, 51 and then heads towards the cold zone of the compressor where the fluid of the heating circuit cools the compressor M1.

In all configurations, it may be arranged so that the outlet circuit for combustion gases (denoted 32) from the burner 11 pass inside an exchanger 21 coupled to the heating circuit, where the exhaust gases (from the combustion) transfer their heat energy to the fluid of the main heating circuit 30.

On the other hand, in all configurations, an air intake preheating exchanger may be provided, denoted 9, which uses the heat energy present in the gases leaving the burner 11 to preheat the fresh air 35 brought to the burner flame. The preheating exchanger 9 here is an air-to-air exchanger, known per se, used with cross-flow in the illustrated example.

The air entering the nozzle of the burner 11 is thus at a temperature comprised between 100° C. and 200° C.

The amount of gas introduced and burned by the burner 11 is controlled by a control unit 1 (see FIG. 9) which contains at least one servo loop for maintaining the temperature of the hot part of the compressor M1 at a target temperature (typically between 600° C. and 700° C.). The control unit 1 controls not only the amount of gas delivered to the burner 11 (with control of the richness) but also the DHW control valve 78 and also if necessary the rotational speed of the regulating motor 17 which will be discussed below. In addition, to manage the need for booster heating, the control unit also controls the position of the selection valve 75 which activates or does not activate the superheating circuit 38.

Specifically, a temperature sensor 61 is provided which captures the temperature of the housing 110 containing the compressor burner (see FIG. 6). The control unit can also receive various temperature and flow rate information 62,63 from the domestic hot water circuit, the general thermostat for controlling the heating in the dwelling which the user uses to set the temperature 66, etc.

Depending on the current configurations and temperatures, this control involves all or nothing decisions (ON/OFF cycling) and/or continuous servocontrols for the flow rate at the burner, for the booster control valve 75, and for the DHW control valve 78.

More specifically, with regard to the composition of the compressor M1, with reference to FIG. 6, it is a “regenerative” heat compressor with a zone for supplying heat energy (hot zone), a cooling zone (cold zone), a closed chamber 8 which communicates with the outside through two check valves, namely an inlet valve 41 (intake) and an outlet valve 42 (discharge).

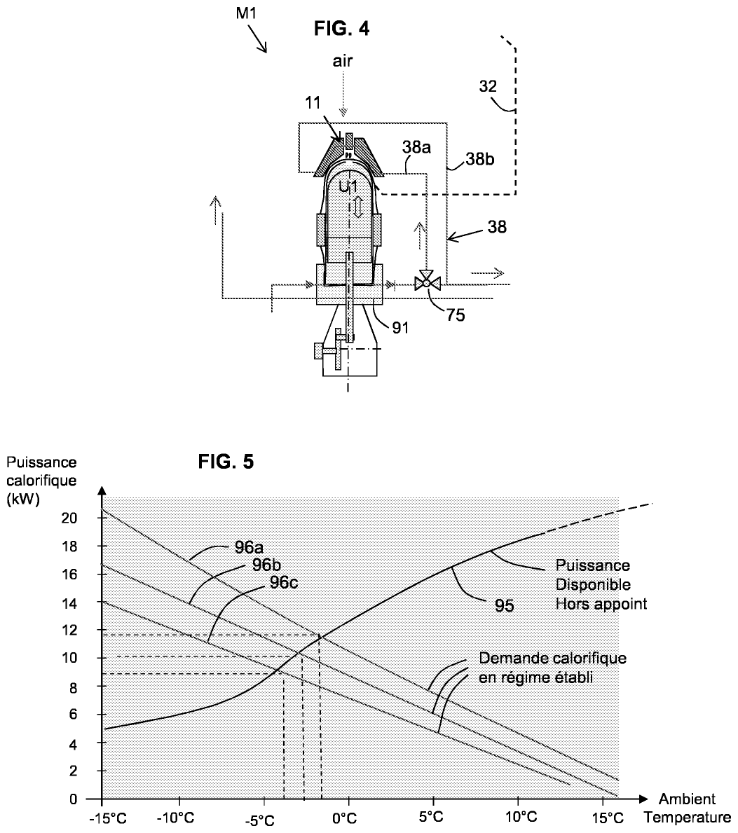

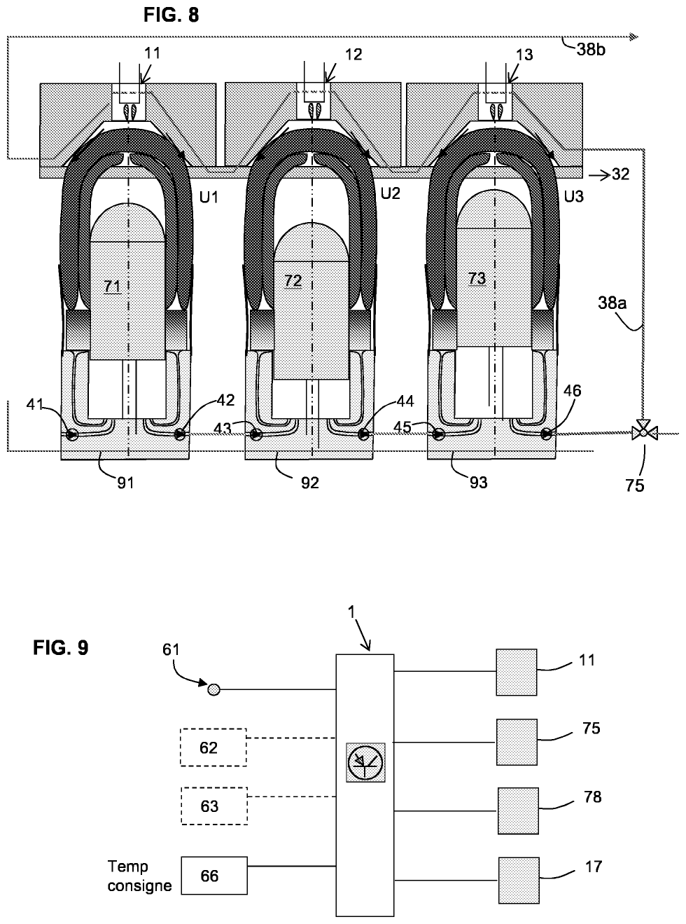

In the example of FIGS. 4 and 6, there is only one compression stage denoted U1, whereas in the example of FIG. 8, it is a configuration with three-stage compression, in other words three compression units U1, U2, U3.

In the closed chamber 8, the compressible fluid occupies a more-or-less constant volume, and a displacing piston 71 is configured to alternate in its movement, from top to bottom in the example shown, in order to move most of the volume of the compressible fluid to the hot zone or to the cold zone. The piston is connected to a connecting rod and crankshaft system in a self-driving system that will be seen below.

As shown in FIG. 6, the compressor is designed around an axial direction X, which is preferably arranged vertically but another arrangement is not excluded. The piston 71, mounted to move within a cylindrical jacket 90, can move along this axis. Said piston separates the first chamber 81 and the second chamber 82, these two chambers being included in the working chamber 8 with the sum of their volumes V1+V2 being substantially constant. The piston 71 has an upper portion that is dome-shaped, for example hemispherical.

The working chamber 8 is structurally contained within an assembly formed by a hot casing 96 and a cold cylinder head 95, with an interposed heat-insulating ring 97.

The first chamber 81, also called the “hot chamber”, is arranged above the piston and thermally coupled to a heat source 11 (a fuel burner 11) which supplies heat directly to the gaseous fluid. The first chamber is a body of revolution with a cylindrical portion having a diameter corresponding to the diameter D1 of the piston and a hemispherical portion at the top, which comprises a central opening 83 for the entry and exit of the compressible fluid. The heat source 11 forms a cap 110 arranged all around the hot chamber 81, with a burner nozzle at the center.

The second chamber 82, also called the “cold chamber”, is arranged below the piston and thermally coupled to a cold source (here the return of the heating circuit 91) thus transferring heat from the compressible fluid to the heating circuit. The second chamber is cylindrical, of diameter D1, and comprises several openings 84 arranged in a circle about the axis, below the piston, for the entry and exit of the compressible fluid.

Around the wall of the cylindrical jacket 90 is arranged a regenerative heat exchanger 19, of the type conventionally used in Stirling-type thermodynamic engines. This exchanger 19 (which will also simply be called a “regenerator” in the following) comprises fluid channels of small cross-sectional area and heat energy storage elements and/or a tight mesh of metal wires. This regenerator 19 is arranged at an intermediate height between the upper end and the lower end of the chamber and has a hot side 19a towards the top and a cold side 19b towards the bottom.

Inside the regenerator, a high temperature gradient is observed between the hot side and the cold side, the hot side having a temperature close to the temperature of the burner cap, namely 700° C., the cold side having a temperature close to the temperature of the heating circuit, namely a temperature between 30° C. and 70° C. depending on the entity(ies) present on the heating circuit.

An annular circulation gap 24 arranged against the inner surface of the hot casing 96 connects the opening 83 of the first chamber to the hot side 19a of the regenerator.

Channels 25 in the cylinder head 95 connect the openings 84 of the second chamber to the cold side 19b of the regenerator.

Thus, when the piston rises, the compressible gas is driven from the first chamber 81 via the circulation gap 24, the regenerator 19, and the channels 25, towards the cold second chamber 82. Conversely, when the piston descends, the compressible gas is driven from the cold second chamber 82 via the channels 25, the regenerator 19, and the circulation gap 24, towards the first chamber 81.

The operation of the compressor is provided by the reciprocating movement of the piston 71 between the bottom dead center BDC and the top dead center TDC, as well as by the action of a suction valve 41 on the inlet, of a discharge check valve 42 on the outlet. The various steps A, B, C, D described below are represented in FIGS. 6 and 7.

Step A.

The piston, initially at the top, moves downwards and the volume of the first chamber 81 increases while the volume of the second chamber 82 decreases. Due to this, the fluid is pushed through the regenerator 19 from bottom to top, and is heated in the process. The pressure Pw increases concomitantly.

Step B.

When the pressure Pw exceeds a certain value, the outlet valve 42 opens and the pressure Pw settles at the compressed fluid outlet pressure P2 and the fluid is expelled to the outlet (the inlet valve 41 of course remains closed during this time). This continues until the piston reaches the bottom dead center.

Step C.

The piston now moves from bottom to top and the volume of the second chamber increases as the first volume of the chamber decreases. As a result, the fluid is pushed through the regenerator 19 from top to bottom, and cools in the process. The pressure Pw decreases concomitantly. The outlet valve 42 is closed at the beginning of the upward movement.

Step D.

When the pressure Pw falls below a certain value, the inlet valve 41 opens and the pressure Pw settles at the fluid inlet pressure P1 and the fluid is sucked into the inlet (the outlet valve 42 of course remains closed during this time). This continues until the piston reaches the top dead center. The inlet valve 41 will close when the piston begins its descent.

The movements of the rod 18 are controlled by a self-driving device 14 acting on one end of the rod. This self-driving device comprises a flywheel 142 mounted so as to rotate about an axis Y1, and a connecting rod 141 connected to said flywheel by a pivot connection, for example a rolling bearing 143. The connecting rod 141 is connected to the rod by another pivot connection, for example a roller bearing 144.

The booster chamber 88 is filled with gaseous working fluid at a pressure denoted Pa. When the device is in operation, the pressure Pa in the booster chamber 88 converges to an average pressure substantially equal to half the sum of the minimum P1 and maximum P2 pressures. Indeed, due to the reduced functional clearance between the ring 118 and the rod 18, in dynamic mode, this very small leakage does not affect operation and remains negligible.

When the flywheel rotates by one turn, the piston sweeps a volume corresponding to the distance between the neutral point and the bottom dead center, multiplied by the diameter D1.

The thermodynamic cycle, as represented in FIG. 7, supplies positive work to the self-driving device.

However, for the initial start-up and in order to be able to regulate the rotational speed, a motor 17 is provided that is coupled to the flywheel 142.

This motor can advantageously be housed in the booster chamber 88 or outside it with magnetic coupling to the wall.

The motor 17 is controlled by a control unit, not shown in the figures; the motor can be controlled to accelerate or slow the rotational speed of the flywheel, the heat flows exchanged being in a more or less proportional relation to the rotational speed of the flywheel. Due to the motor 17, the control unit can adjust the rotational speed between typically 100 rpm and 500 rpm, preferably within the range [200-300 rpm].

One will also note that the motor 17 serves to start the self-driving device 14.

Note that the piston 71 is not a power-receiving piston (unlike an internal combustion engine or a conventional Stirling engine) but simply a displacement piston; power is supplied in the form of an increase in the pressure of the working gas.

One will note that V1+V2+Vchannel=Vtotal if we ignore variations in the volume of the rod 18, V1 being the volume of the first chamber, V2 being the volume of the second chamber, and Vchannel being the volume of the conduits 24,25. It is preferably arranged to have a dead volume that is as low as possible with pipes of smaller cross-sectional area, for example Vchannel<10% V1+V2 will be obtained.

FIG. 8 illustrates a complementary characteristic, namely a configuration with three compression stages, in other words three compression units U1, U2, U3.

The second stage U2 and the third stage U3 are similar or analogous in every respect to the first stage U1; each comprises a burner 12,13 where the combustion of gas mixed with the indrawn air occurs, and a displacing piston 72,73 similar to that of the first stage and whose movement and rotational speed are independent of the first.

Advantageously, the stages operate independently: the rotational speed may be different from one stage to another.

One will note that the heating circuit cools the three cold zones of the compressors, via the successive channels 93, 92 and 91.

The outlet of the first stage, in other words valve 42, is connected to the inlet of the second stage, in other words valve 43. The outlet of the second stage, in other words valve 44, is connected to the inlet of the third stage, in other words valve 45. The outlet of valve 46 forms the general outlet of the compressor 1.

The staging of the pressures can typically be as follows: the inlet pressure of the first stage U1 is about 20 bar; the discharge pressure of the first stage (second stage inlet) is about 40 bar; the discharge pressure of the second stage U2 (third stage inlet) is about 60 bar; the output of the third stage U3 may be about 80 bar.

It may be arranged so that the three cold zones of the three stages U1 U2 U3 form a single piece called the cold cylinder head.

Of course, one can also have a two-stage configuration U1 U2.

In addition, it is possible to provide a configuration in which two (or more) stages are arranged in parallel, the stages being similar to those described above.

In general, one will note that the fuel used in the burner may be natural gas, or biogas of plant or animal origin, or light hydrocarbon waste from industrial petroleum processes.

Apart from the case of domestic hot water, a need for significant power exists in the case of a second home that must be brought to normal temperatures when the occasional occupants arrive. The configuration presented allows delivering more than 20 kW for a relatively long time in order to heat or cool the dwelling.

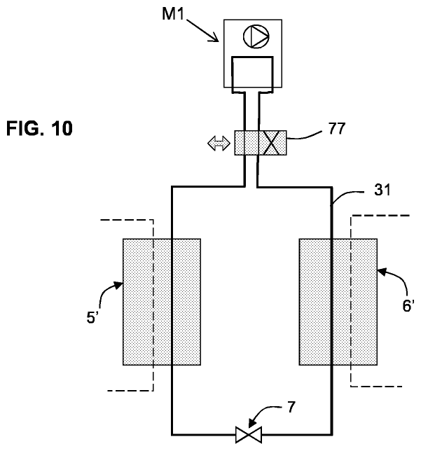

As illustrated in FIG. 10, the heat compressor 1 described above can be used in the context of the diagrams of FIGS. 1 to 3, in heating mode of course, but also for air conditioning due to its reversibility.

In this case, in air conditioning mode, heat will be taken from the heating circuit 30 (for example at the underfloor heating) and the collected heat will be directed either to the domestic hot water circuit 15, 16, or to the exterior unit 4.

This result can be obtained by reversing the role of the evaporation and condensation exchangers 5′,6′ on the compressible gas loop 31.

For the sake of clarity, the four-way valve 77 which makes it possible to reverse the direction of flow of the fluid has not been shown in FIGS. 1 to 3, but the principle is represented in FIG. 10 where the four-way valve 77 has a normal position called heating mode and a special position (inverted) called air conditioning mode, which reverses the roles of the exchangers denoted 5′ and 6′ as is known per se.

For the sake of clarity, some components in the boiler system have not been shown although they may also be present. These include:

expansion vessels on water circuits 34, 30;

faucets for filling and purging the heating circuit;

faucets for filling and purging the CO2 circuit; and

various manometers and temperature sensors necessary for the control unit to control the system.

### Summary of the Circuits

30: heating circuit
31: CO2 compressible fluid
32: combustion gases
33: bypass for DHW
34: glycolated water (exchange with the outside)
35: heated intake air
36: DHW specific circuit

1. A thermodynamic boiler for at least delivering heat into at least one heating circuit, the boiler comprising:
at least one compressor that performs a compression function of a heat pump loop using a refrigerant, and
a fuel burner which delivers heat at least into the refrigerant, wherein the fuel burner delivers the heat into the refrigerant, downstream of the compressor.

2. The thermodynamic boiler according to claim 1, wherein the refrigerant is a compressible fluid of type R744.

3. The thermodynamic boiler according to claim 1, wherein the compressor is a heat compressor comprising at least one compression stage with reciprocating piston, the fuel burner further forming a heat source for the compressor and the heating circuit forming a cold source for the compressor.

4. The thermodynamic boiler according to claim 3, comprising a domestic hot water circuit.

5. The thermodynamic boiler according to claim 3, wherein the burner of the compressor forms the only burner of the boiler.

6. Thermodynamic boiler according to claim 3, comprising a circuit for superheating the refrigerant in or near the burner, and a booster control valve for selectively allowing the refrigerant to circulate in said superheating circuit.

7. The thermodynamic boiler according to claim 3, wherein the burner of the compressor allows delivering all the power of the boiler.

8. The thermodynamic boiler according to claim 4, comprising an exchanger forming a thermal interface between the heat pump loop and the heating circuit, the exchanger comprising a high temperature exchanger and a low temperature exchanger, the high temperature exchanger being coupled to the domestic hot water circuit.

9. The thermodynamic boiler according to claim 3, wherein the heat pump loop comprises two circuits in cascade, namely a working circuit of R744 compressible gas and a circuit of glycolated water.

10. The thermodynamic boiler according to claim 3, further comprising a modulation unit and a motor for regulating, namely increasing and/or decreasing, a rotational speed of the compressor.

11. The thermodynamic boiler according to claim 3, wherein the compressor comprises at least two compression stages in series, including a first compression stage and a second compression stage.

12. The thermodynamic boiler according to claim 11, wherein the compressor includes a third compression stage in series with the second compression stage.
